(19) United States
(12) Patent Application Publication
(10) Pub. No.: US 2016/0036609 A1
(43) Pub. Date: Feb. 4, 2016

(54) METHOD AND APPARATUS FOR TRANSMITTING/RECEIVING DATA IN WIRELESS COMMUNICATION SYSTEM SUPPORTING NON-BINARY CHANNEL CODE

(71) Applicant: Samsung Electronics Co., Ltd, Gyeonggi-do (KR)

(72) Inventors: Seok-Ki Ahn, Suwon-si (KR); Woo-Myoung Park, Suwon-si (KR); Min Sagong, Suwon-si (KR); Chi-Woo Lim, Suwon-si (KR); Sung-Nam Hong, Anyang-si (KR)

(21) Appl. No.: 14/815,653

(22) Filed: Jul. 31, 2015

(30) Foreign Application Priority Data
Jul. 31, 2014 (KR) 10-2014-0098323

(51) Int. Cl. H04L 27/26; H04B 7/04; H04L 1/00

(52) U.S. Cl. CPC H04L 27/2602; H04L 1/0003; H04B 7/0413

(57) ABSTRACT

The present disclosure relates to a pre-5th-Generation (5G) or 5G communication system to be provided for supporting higher data rates beyond 4th-Generation (4G) communication system such as a Long Term Evolution (LTE). A method for transmitting data in a transmitting apparatus in a wireless communication system supporting a non-binary channel code is provided. The method includes generating at least one modulation symbol by modulating at least one code symbol based on a predetermined modulation scheme; and transmitting the at least one modulation symbol to a receiving apparatus, wherein the generating of the at least one modulation symbol comprises generating the at least one modulation symbol from the at least one code symbol to thereby reduce a number of complex modulation symbols generated from a plurality of code symbols.

### CROSS-REFERENCE TO RELATED APPLICATION(S) AND CLAIM OF PRIORITY

The present application is related to and claims the benefit under 35 U.S.C. §119(a) of a Korean patent application filed in the Korean Intellectual Property Office on Jul. 31, 2014 assigned Serial No. 10-2014-0098323, the entire disclosure of which is incorporated herein by reference.

### TECHNICAL FIELD

The present disclosure relates to a method and apparatus for transmitting/receiving data in a wireless communication system supporting a non-binary channel code.

### BACKGROUND

To meet the demand for wireless data traffic, which has increased since deployment of 4th-generation (4G) communication systems, efforts have been made to develop an improved 5th-generation (5G) or pre-5G communication system. Therefore, the 5G or pre-5G communication system is also called a ‘beyond 4G network’ or a ‘post long-term evolution (LTE) system’.

It is considered that the 5G communication system will be implemented in millimeter wave (mmWave) bands, e.g., 60 GHz bands, so as to accomplish higher data rates. To reduce propagation loss of radio waves and increase a transmission distance, a beam forming technique, a massive multiple-input multiple-output (MIMO) technique, a full dimensional MIMO (FD-MIMO) technique, an array antenna technique, an analog beam forming technique, and a large scale antenna technique are discussed in 5G communication systems.

In addition, in 5G communication systems, development for system network improvement is under way based on advanced small cells, cloud radio access networks (RANs), ultra-dense networks, a device-to-device (D2D) communication, a wireless backhaul, a moving network, a cooperative communication, coordinated multi-points (CoMP), reception-end interference cancellation, and the like.

In the 50 system, a hybrid frequency shift keying (FSK) and quadrature amplitude modulation (QAM) modulation (FQAM) and a sliding window superposition coding (SWSC) as an advanced coding modulation (ACM) scheme, and a filter bank multi carrier (FBMC) scheme, a non-orthogonal multiple Access (NOMA) scheme, and a sparse code multiple access (SCMA) scheme as an advanced access technology have been developed.

A wireless communication system or mobile communication system has evolved to support a high data rate in order to process various data such as an image, radio data, and the like. So, the wireless communication system or mobile communication system has evolved to increase efficiency of the wireless communication system or mobile communication system using various channel encoding schemes in order to support the high data rate.

In a wireless communication system, a channel code which is used on channel encoding is classified into a binary channel code and a non-binary channel code. Performance of a binary channel code such as a turbo code and a low density parity check (LDPC) code which are used in the wireless communication system is almost close to theoretical maximum channel capacity.

So, there is a need of using a channel code of which performance is better than performance of a binary channel code in a wireless communication system. Here, under various channel environments and modulation schemes, the non-binary channel code has a gain compared to a binary channel code in a channel capacity aspect. A typical example of the non-binary channel code is a non-binary LDPC code.

The above information is presented as background information only to assist with an understanding of the present disclosure. No determination has been made, and no assertion is made, as to whether any of the above might be applicable as prior art with regard to the present disclosure.

### SUMMARY

To address the above-discussed deficiencies, it is a primary object to provide, for use in a method and apparatus for encoding/decoding data in a wireless communication system supporting a non-binary channel code.

Another aspect of the present disclosure is to provide a method and apparatus for encoding/decoding data thereby supporting various modulation schemes in a wireless communication system supporting a non-binary channel code.

Another aspect of the present disclosure is to provide a method and apparatus for encoding/decoding data thereby generating a modulation symbol based on a Galois field element value of a non-binary channel code and a modulation order in a wireless communication system supporting a non-binary channel code.

Another aspect of the present disclosure is to provide a method and apparatus for encoding/decoding data thereby supporting adaptive modulation and encoding using one non-binary channel code in a wireless communication system supporting a non-binary channel code.

Another aspect of the present disclosure is to provide a method and apparatus for mapping a code symbol on a modulation symbol thereby reducing the number of modulation symbols generated from a plurality of code symbols in a wireless communication system supporting a non-binary channel code.

Another aspect of the present disclosure is to provide a method and apparatus for encoding/decoding data thereby providing a signal constellation for bits included in a modulation symbol generated from a plurality of code symbols in a wireless communication system supporting a non-binary channel code.

Another aspect of the present disclosure is to provide a method and apparatus for encoding/decoding data thereby demodulating a received symbol with a low complexity in a signal receiving apparatus in a wireless communication system supporting a non-binary channel code.

Another aspect of the present disclosure is to provide a method and apparatus for determining a probability value for a received symbol which corresponds to a modulation symbol generated from a plurality of code symbols in a wireless communication system supporting a non-binary channel code.

In accordance with an aspect of the present disclosure, a method for transmitting data in a transmitting apparatus in a wireless communication system is provided. The method includes generating at least one modulation symbol by modulating at least one code symbol based on a predetermined modulation scheme; and transmitting the at least one modulation symbol to a receiving apparatus, wherein the generating of the at least one modulation symbol comprises generating the at least one modulation symbol from the at least one code symbol thereby minimizing a number of complex modulation symbols generated from a plurality of code symbols.

In accordance with another aspect of the present disclosure, a method for receiving data in a receiving apparatus in a wireless communication system is provided. The method includes receiving at least one modulation symbol that is generated from at least one code symbol which is encoded based on a predetermined non-binary encoding scheme based on a predetermined modulation scheme; demodulating the received at least one modulation symbol; and decoding the demodulated symbol, wherein the demodulating the received at least one modulation symbol includes demodulating the received at least one modulation symbol by calculating a probability vector of each of the at least one modulation symbol on the received modulation symbol basis.

Preferably, the demodulating of the received at least one modulation symbol further comprises: for a complex received symbol as a received symbol for a complex modulation symbol which is generated from a plurality of code symbols, generating a reduced probability vector V1 with a size which corresponds to bits of which the number is less than a bit size of the complex received symbol per bits which are generated from different code symbols; for a simple received symbol as a received symbol for a simple modulation symbol which is generated from one code symbol, generating a probability vector V2 with a size of the simple modulation symbol; and generating a probability vector V3 for a code symbol by multiplying the reduced probability vector V1 for the complex received symbol and the probability vector V2 for the simple received symbol.

Preferably, the complex modulation symbol is modulated based on a signal constellation which is generated based on a Grey rule.

In accordance with another aspect of the present disclosure, a method for receiving data in a receiving apparatus in a wireless communication system is provided. The method includes receiving at least one modulation symbol from a transmitting apparatus, wherein the at least one modulation symbol is generated by modulating at least one code symbol based on a predetermined modulation scheme, and wherein the at least one modulation symbol is generated from the at least one code symbol to thereby reduce a number of complex modulation symbols that are generated from a plurality of code symbols.

In accordance with another aspect of the present disclosure, a transmitting apparatus in a wireless communication system is provided. The transmitting apparatus includes a modulator configured to generate at least one modulation symbol by modulating at least one code symbol based on a predetermined modulation scheme; and a transmitter configured to transmit the at least one modulation symbol to a receiving apparatus, wherein the modulator generates the at least one modulation symbol from the at least one code symbol thereby minimizing a number of complex modulation symbols generated from a plurality of code symbols.

In accordance with another aspect of the present disclosure, a receiving apparatus in a wireless communication system is provided. The receiving apparatus includes a receiver configured to receive at least one modulation symbol that is generated from at least one code symbol which is encoded based on a predetermined non-binary encoding scheme based on a predetermined modulation scheme; a demodulator configured to demodulate the received at least one modulation symbol; and a decoder configured to decode the demodulated modulation symbol, wherein the demodulator demodulates the received at least one modulation symbol by calculating a probability vector of each of the at least one modulation symbol on the received modulation symbol basis.

Preferably, for a complex received symbol as a received symbol for a complex modulation symbol which is generated from a plurality of code symbols, the demodulator is configured to generate a reduced probability vector V1 with a size which corresponds to bits of which the number is less than a bit size of the complex received symbol per bits which are generated from different code symbols, for a simple received symbol as a received symbol for a simple modulation symbol which is generated from one code symbol, the demodulator is configured to generate a probability vector V2 with a size of the simple modulation symbol, and the demodulator is configured to generate a probability vector V3 for a code symbol by multiplying the reduced probability vector V1 for the complex received symbol and the probability vector V2 for the simple received symbol.

Preferably, the complex modulation symbol is modulated based on a signal constellation which is generated based on a Grey rule.

In accordance with another aspect of the present disclosure, a receiving apparatus in a wireless communication system is provided. The receiving apparatus includes a receiver configured to receive at least one modulation symbol from a transmitting apparatus, wherein the at least one modulation symbol is generated by modulating at least one code symbol based on a predetermined modulation scheme, and wherein the at least one modulation symbol is generated from the at least one code symbol to thereby reduce a number of complex modulation symbols that are generated from a plurality of code symbols.

Other aspects, advantages, and salient features of the disclosure will become apparent to those skilled in the art from the following detailed description, which, taken in conjunction with the annexed drawings, discloses exemplary embodiments of the disclosure.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a block diagram a structure of a wireless communication system according to an embodiment of the present disclosure.

FIG. 2 illustrates a mapping between a code symbol and a modulation symbol for calculating an LLR value on a bit basis in a wireless communication system supporting a non-binary channel code according to an embodiment of the present disclosure;

FIG. 3 illustrates an example of a scheme of mapping a code symbol on a modulation symbol in a wireless communication system supporting a non-binary channel code according to an embodiment of the present disclosure;

FIG. 4 illustrates another example of a scheme of mapping a code symbol on a modulation symbol in a wireless communication system supporting a non-binary channel code according to an embodiment of the present disclosure;

FIG. 5 illustrates still another example of a scheme of mapping a code symbol on a modulation symbol in a wireless communication system supporting a non-binary channel code according to an embodiment of the present disclosure;

FIG. 6 illustrates a mapping relation between a code symbol and a modulation symbol which is based on an element value of a Galois field and a modulation order in a wireless communication system supporting a non-binary channel code according to an embodiment of the present disclosure;

FIG. 7 illustrates a signal constellation of bits included in a modulation symbol generated from a plurality of code symbols in a wireless communication system supporting a non-binary channel code according to an embodiment of the present disclosure;

FIG. 8 illustrates a demodulation scheme of a signal receiving apparatus in a wireless communication system supporting a non-binary channel code according to an embodiment of the present disclosure;

FIG. 9 illustrates an operating process of a signal transmitting apparatus in a wireless communication system supporting a non-binary channel code according to an embodiment of the present disclosure;

FIG. 10 illustrates an operating process of a signal receiving apparatus in a wireless communication system supporting a non-binary channel code according to an embodiment of the present disclosure; and

FIG. 11 is a graph illustrating performance of a data encoding/decoding scheme proposed in a wireless communication system supporting a non-binary channel code according to an embodiment of the present disclosure.

Throughout the drawings, it should be noted that like reference numbers are used to depict the same or similar elements, features, and structures.

### DETAILED DESCRIPTION

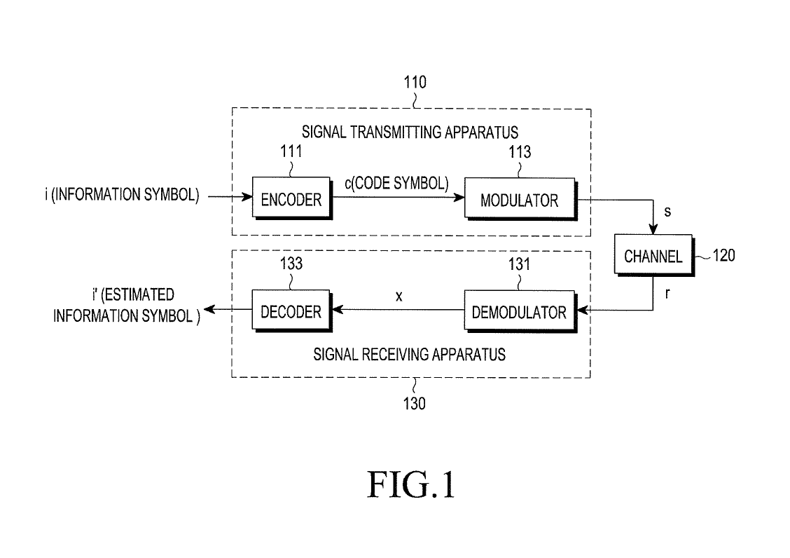

FIGS. 1 through 11, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device. The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventors to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Although ordinal numbers such as “first,” “second,” and so forth will be used to describe various components, those components are not limited herein. The terms are used only for distinguishing one component from another component. For example, a first component may be referred to as a second component and likewise, a second component may also be referred to as a first component, without departing from the teachings of the present disclosure. The term “and/or” used herein includes any and all combinations of one or more of the associated listed items.

The terminology used herein is for the purpose of describing various embodiments only and is not intended to be limiting. As used herein, the singular forms are intended to include the plural forms as well, unless the context clearly indicates otherwise. It will be further understood that the terms “comprises” and/or “has,” when used in this specification, specify the presence of a stated feature, number, step, operation, component, element, or combination thereof, but do not preclude the presence or addition of one or more other features, numbers, steps, operations, components, elements, or combinations thereof.

The terms used herein, including technical and scientific terms, have the same meanings as terms that are generally understood by those skilled in the art, as long as the terms are not differently defined. It should be understood that terms defined in a generally-used dictionary have meanings coinciding with those of terms in the related technology.

According to various embodiments of the present disclosure, an electronic device may include communication functionality. For example, an electronic device may be a smart phone, a tablet personal computer (PC), a mobile phone, a video phone, an e-book reader, a desktop PC, a laptop PC, a netbook PC, a personal digital assistant (PDA), a portable multimedia player (PMP), an mp3 player, a mobile medical device, a camera, a wearable device (e.g., a head-mounted device (HMD), electronic clothes, electronic braces, an electronic necklace, an electronic appcessory, an electronic tattoo, or a smart watch), and/or the like.

According to various embodiments of the present disclosure, an electronic device may be a smart home appliance with communication functionality. A smart home appliance may be, for example, a television, a digital video disk (DVD) player, an audio, a refrigerator, an air conditioner, a vacuum cleaner, an oven, a microwave oven, a washer, a dryer, an air purifier, a set-top box, a TV box (e.g., Samsung HomeSync™, Apple TV™, or Google TV™), a gaming console, an electronic dictionary, an electronic key, a camcorder, an electronic picture frame, and/or the like.

According to various embodiments of the present disclosure, an electronic device may be a medical device (e.g., magnetic resonance angiography (MRA) device, a magnetic resonance imaging (MRI) device, computed tomography (CT) device, an imaging device, or an ultrasonic device), a navigation device, a global positioning system (GPS) receiver, an event data recorder (EDR), a flight data recorder (FDR), an automotive infotainment device, a naval electronic device (e.g., naval navigation device, gyroscope, or compass), an avionic electronic device, a security device, an industrial or consumer robot, and/or the like.

According to various embodiments of the present disclosure, an electronic device may be furniture, part of a building/structure, an electronic board, electronic signature receiving device, a projector, various measuring devices (e.g., water, electricity, gas or electro-magnetic wave measuring devices), and/or the like that include communication functionality.

According to various embodiments of the present disclosure, an electronic device may be any combination of the foregoing devices. In addition, it will be apparent to one having ordinary skill in the art that an electronic device according to various embodiments of the present disclosure is not limited to the foregoing devices.

An embodiment of the present disclosure provides a method and apparatus for encoding/decoding data in a wireless communication system supporting a non-binary channel code.

An embodiment of the present disclosure provides a method and apparatus for encoding/decoding data thereby supporting various modulation schemes in a wireless communication system supporting a non-binary channel code.

An embodiment of the present disclosure provides a method and apparatus for encoding/decoding data thereby generating a modulation symbol based on a Galois field element value of a non-binary channel code and a modulation order in a wireless communication system supporting a non-binary channel code.

An embodiment of the present disclosure provides a method and apparatus for encoding/decoding data thereby supporting adaptive modulation and encoding using one non-binary channel code in a wireless communication system supporting a non-binary channel code.

An embodiment of the present disclosure provides a method and apparatus for mapping a code symbol on a modulation symbol thereby reducing or minimizing the number of modulation symbols generated from a plurality of code symbols in a wireless communication system supporting a non-binary channel code.

An embodiment of the present disclosure provides a method and apparatus for encoding/decoding data thereby providing a signal constellation for bits included in a modulation symbol generated from a plurality of code symbols in a wireless communication system supporting a non-binary channel code.

An embodiment of the present disclosure provides a method and apparatus for encoding/decoding data thereby demodulating a received symbol with a low complexity in a signal receiving apparatus in a wireless communication system supporting a non-binary channel code.

An embodiment of the present disclosure provides a method and apparatus for determining a probability value for a received symbol which corresponds to a modulation symbol generated from a plurality of code symbols in a wireless communication system supporting a non-binary channel code.

A method and apparatus proposed in various embodiments of the present disclosure may be applied to various communication systems such as an institute of electrical and electronics engineers (IEEE) 802.11 communication system, an IEEE 802.16 communication system, a digital video broadcast system such as a mobile broadcast service such as a digital multimedia broadcasting (DMB) service, a digital video broadcasting-handheld (DVP-H), an advanced television systems committee-mobile/handheld (ATSC-M/H) service, and the like, and an internet protocol television (IPTV), a moving picture experts group (MPEG) media transport (MMT) system, an evolved packet system (EPS), a long term evolution (LTE) mobile communication system, an LTE-advanced (LTE-A) mobile communication system, a high speed downlink packet access (HSDPA) mobile communication system, a high speed uplink packet access (HSUPA) mobile communication system, a high rate Packet data (HRPD) mobile communication system proposed in a 3rd generation project partnership 2 (3GPP2), a wideband code division multiple access (WCDMA) mobile communication system proposed in the 3GPP2, a code division multiple access (CDMA) mobile communication system proposed in the 3GPP2, a mobile internet protocol (Mobile IP) system and/or the like.

In a wireless communication system supporting a non-binary channel code according to an embodiment of the present disclosure, a signal transmitting apparatus generates modulation symbols thereby reducing or minimizing the number of complex modulation symbols which are generated from a plurality of code symbols and maximizing the number of simple modulation symbols which are generated from one code symbol.

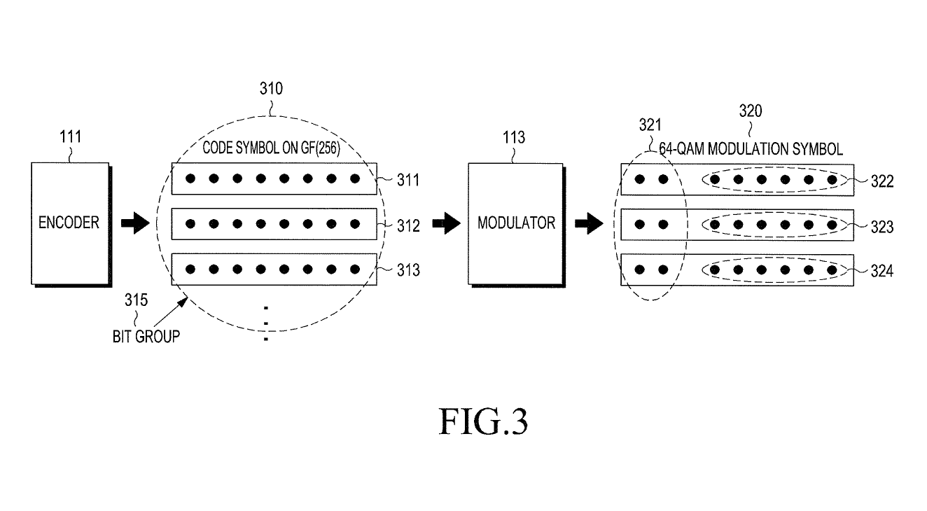

Which modulation symbol is generated as a complex modulation symbol may be predetermined between a signal transmitting apparatus and a signal receiving apparatus or may be determined based on a default value. Alternatively, a signal transmitting apparatus generates a modulation symbol using a plurality of code symbols, and may transmit information on which modulation symbol is a complex modulation symbol to a signal receiving apparatus. A modulation scheme used in signal transmitting apparatus will be described with reference to FIG. 3, and a detailed description will be omitted herein.

Meanwhile, the signal receiving apparatus generates a probability vector on a symbol basis upon demodulating received symbols. For a complex received symbol, the signal receiving apparatus calculates a probability vector V1 of which a size corresponds to the number of bits included in a related code symbol among bits included in the complex modulation symbol for each of a plurality of code symbols. Here, the complex modulation symbol is received in the signal receiving apparatus through a channel, and the complex modulation symbol after passing the channel is the complex received symbol. Further, the probability vector V1 will be referred to as a reduced probability vector.

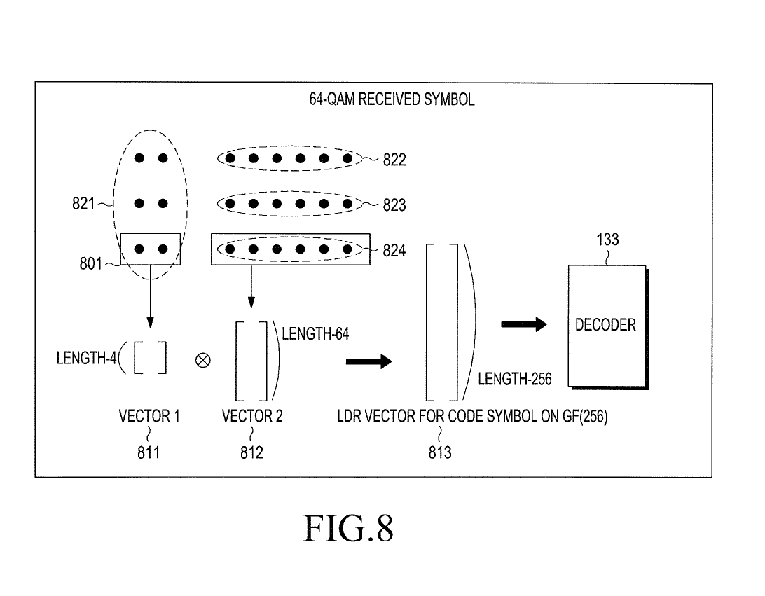

For a simple received symbol, the signal receiving apparatus detects a probability vector V2 of which a size corresponds to the number of bits included in the simple modulation symbol. Here, the simple modulation symbol is received in the signal receiving apparatus through a channel, and the simple modulation symbol after passing the channel is the simple received symbol. For one code symbol, the signal receiving apparatus may detect a probability vector V3 of which a size corresponds to the number of bits included in the code symbol by multiplying the probability vector V1 and the probability vector V2. After detecting the probability vector V3, the signal receiving apparatus may decode the detected probability vector V3. The demodulating operation of the signal receiving apparatus will be described with reference to FIG. 8, so a detailed description will be omitted herein.

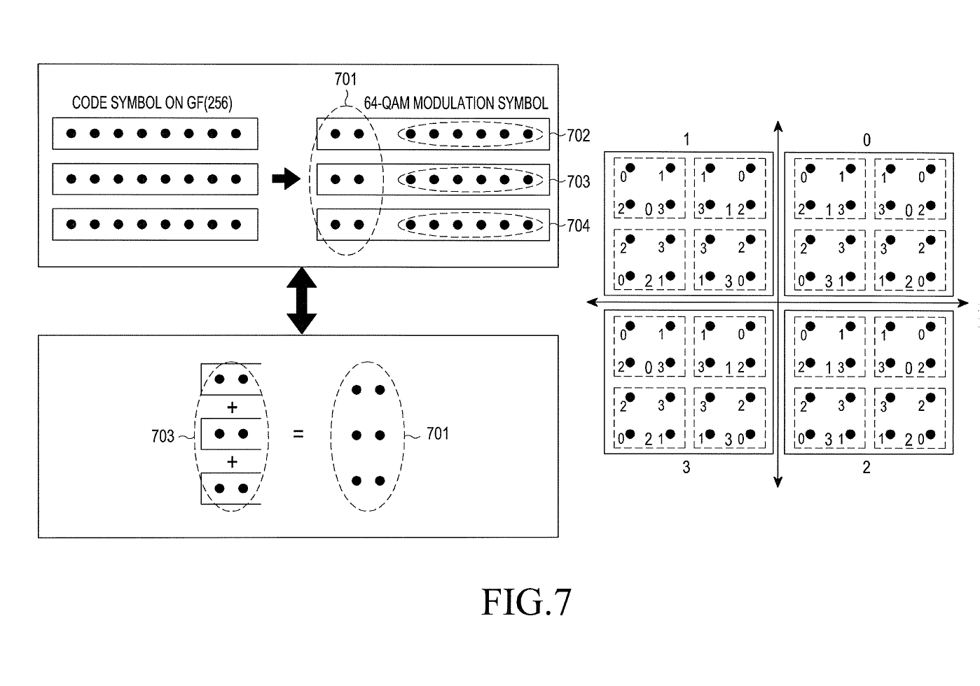

In an embodiment of the present disclosure, a signal transmitting apparatus performs a modulating operation thereby reducing or minimizing the number of complex modulation symbols and maximizing the number of simple modulation symbols, and a signal receiving apparatus performs an operation of detecting a reduced probability vector per code symbol bit for a complex received symbol. That is, bits included in a plurality of code symbols are included in one complex modulation symbol. So, in an embodiment of the present disclosure, a signal transmitting apparatus generates a modulation symbol based on a signal constellation which is generated based on a Grey rule in order to reduce or minimize error propagation which occurs since a transmission symbol is incorrectly detected as a neighbor constellation on a signal constellation. Here, a complex modulation symbol is modulated using a signal constellation which is generated based on the Grey rule with a size of a code symbol in which M bits included in the complex modulation symbol are included. This signal constellation will be described with reference to FIG. 7, and a detailed description will be omitted herein.

In a wireless communication system supporting a non-binary channel code according to an embodiment of the present disclosure, a modulating operation and a demodulating operation are performed according to the described scheme, so complexity due to a demodulating operation may be decreased while maintaining a channel capacity of a non-binary channel code.

Various embodiments of the present disclosure are described below.

FIG. 1 illustrates an inner structure of a wireless communication system according to an embodiment of the present disclosure.

Referring to FIG. 1, the wireless communication system includes a signal transmitting apparatus 110 and a signal receiving apparatus 130.

The signal transmitting apparatus 110 includes an encoder 111, a modulator 113, and a transmitter (not shown in FIG. 1). Here, the encoder 111 is a channel encoder.

The signal receiving apparatus 130 includes a receiver (not shown in FIG. 1), a demodulator 131, and a decoder 133.

When an information symbol i to be transmitted occurs, the information symbol i is input to the encoder 111. The encoder 111 encodes the input information symbol i based on a preset encoding scheme to generate a code symbol c, and outputs the code symbol c to the modulator 113. The modulator 113 modulates the code symbol c based on a preset modulation scheme to generate a modulation symbol s, and outputs the modulation symbol s to the transmitter. The transmitter processes the modulation symbol s based on a preset transmission processing scheme to generate a transmission signal, and transmits the transmission signal to the signal receiving apparatus 130. The transmission signal is transmitted to the signal receiving apparatus 130 through a channel 120.

The receiver in the signal receiving apparatus 130 receives a signal from the signal transmitting apparatus 110, and a received signal which is received in the receiver, i.e., a received symbol r is input to the demodulator 131. The demodulator 131 demodulates the received symbol r input from the receiver based on a preset demodulation scheme to output the demodulated signal to the decoder 133. The demodulation scheme corresponds to the modulation scheme which is used in the signal transmitting apparatus 110. That is, the demodulator 131 calculates a probability value (or a probability vector) for the modulation symbol s from the received symbol r input from the receiver, and outputs the calculated probability value (or the calculated probability vector) to the decoder 133. The decoder 133 outputs an estimated value for the information symbol i, i.e., an estimated information symbol i′ based on the probability value (or the probability vector) output from the demodulator 131.

Here, a process of transferring a probability value from the demodulator 131 to the decoder 133 may be different according to whether a channel code is a binary channel code or a non-binary channel code, and this will be described below.

In a case that the channel code is the binary channel code, the process of transferring the probability value from the demodulator 131 to the decoder 133 will be described below.

If the channel code is the binary channel code, the demodulator 131 calculates a log-likelihood ratio (LLR) value for each bit included in the received symbol r from probability values for a transmitted symbol s which is calculated from the received symbol r, and outputs the calculated LLR value to the decoder 115. Here, a probability value for the transmitted symbol s is p(r|s). If the channel code is the binary channel code, information is lost in a process of calculating an LLR value on a bit basis from the probability values, and channel capacity loss occurs due to this information loss.

A process of transferring a probability value from the demodulator 131 to the decoder 133 in a case that the channel code is the non-binary channel code will be described below.

If the channel code is the non-binary channel code, the demodulator 131 needs to output a probability value p(r|s) for the transmission symbol s which is calculated from the received symbol r to the decoder 133 in order to acquire a channel capability gain of the non-binary channel code. In a case that the channel code is the non-binary channel code, if the number of elements q on a Galois field (GF) in which the non-binary channel code is defined is equal to a modulation order M of a modulation scheme, each point on a signal constellation of a related modulation scheme such as an M-ary quadrature amplitude modulation (M-QAM) scheme, an M-ary frequency quadrature amplitude modulation (M-FQAM) scheme, and the like corresponds to each element on a GF(q) which a code symbol may have one to one. This case may be a case that the number of bits included in a code symbol is equal to the number of bits included in a modulation symbol, for example, a case that a non-binary channel code of a length 6 on a GF(64) and a modulation symbol of a length 6 according to a 64-QAM modulation scheme are used. If q is equal to M, probability values which are calculated in the demodulator 131 may be a priori probability value, so the demodulator 131 may transfer the calculated probability values to the decoder 133.

In the case that the channel code is the non-binary channel code, if q is different from M, a process of calculating a priori probability value of a code symbol from the received symbol r is complex. This case may be a case that the number of bits included in a code symbol is different from the number of bits included in a modulation symbol, for example, a case that a non-binary channel code of a length 6 on a GF(256) and a modulation symbol of a length 6 which is based on a 64-QAM modulation scheme are used.

Meanwhile, in a wireless communication system using a non-binary channel code on a GF(q)(for example, q=256), M for an adaptive modulation and coding (AMC) scheme (for example, M=16, 64, 256) may be different from q (in the described example, q=256, and M=16 or M=64).

So, in the wireless communication system using the non-binary channel code as the channel code, it becomes difficult to support various modulation schemes using an arbitrary non-binary channel code on a GF(q).

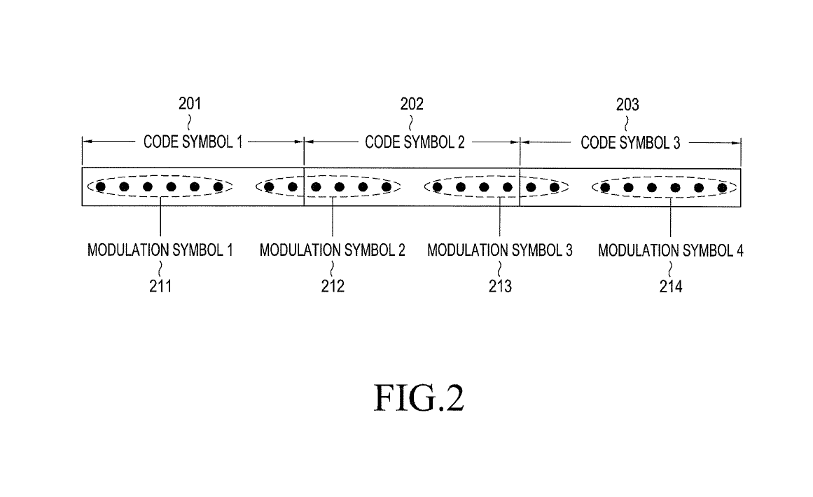

So, in order to solve this case, a scheme of calculating an LLR value on a bit basis for a received symbol r like a binary channel code may be considered. A process of calculating an LLR value on a bit basis for a received symbol r in a case that a non-binary channel code is used as a channel code will be described with reference to FIG. 2.

FIG. 2 illustrates a mapping between a code symbol and a modulation symbol for calculating an LLR value on a bit basis in a wireless communication system supporting a non-binary channel code according to an embodiment of the present disclosure.

Referring to FIG. 2, it will be assumed that a channel code is a non-binary channel code on a GF(256), and a modulation scheme is a 64-QAM modulation scheme. Since the non-binary channel is the non-binary channel on the GF(256), so one code symbol includes eight bits. Since the modulation scheme is the 64-QAM modulation scheme, one modulation symbol includes six bits.

Further, three code symbols 201, 202, and 203, i.e., a code symbol 1 201, a code symbol 2 202, and a code symbol 3 203, and four modulation symbols 211, 212, 213, and 214, i.e., a modulation symbol 1 211, a modulation symbol 2 212, a modulation symbol 3 213, and a modulation symbol 4 214 are illustrated in FIG. 2.

In FIG. 2, the four modulation symbols 211, 212, 213, and 214 are generated based on 24 bits included in the three code symbols 201, 202, and 203, and each of the four modulation symbols 211, 212, 213, and 214 includes six bits. That is, if a signal transmitting apparatus generates and transmits modulation symbols with the described scheme, a signal receiving apparatus may calculate log 2M (in FIG. 2, log 264=6) LLR values on a bit basis for bits included in a received symbol, and generate a log density ratio (LDR) vector of length 256 which is required for decoding a non-binary channel code on GF(256) by grouping the calculated LLR values by log 2q (in FIG. 2, log 2256=8).

As described in FIG. 2, in a scheme of generating a modulation symbol based on bits included in a code symbol, the number of complex modulation symbols which are generated from a plurality of code symbols becomes increased.

In FIG. 2, the modulation symbol 2 212 is a complex modulation symbol which is generated from the code symbol 2 202, and the modulation symbol 3 213 is a complex modulation symbol which is generated from the code symbol 2 202 and the code symbol 3 203. If modulation symbols are sequentially generated based on bits included in code symbols according to this scheme, the number of complex modulation symbols becomes increased, so there is a need of many memories for calculating a probability value per bit in a process of performing a demodulating operation in a signal receiving apparatus and complexity becomes increased.

A scheme of generating a modulation symbol from a code symbol according to an embodiment of the present disclosure will be described below.

FIG. 3 illustrates an example of a scheme of mapping a code symbol on a modulation symbol in a wireless communication system supporting a non-binary channel code according to an embodiment of the present disclosure.

Referring to FIG. 3, as described in FIG. 1, an encoder 111 generates a plurality of code symbols 310 to output the plurality of code symbols 310 to a modulator 113, and the modulator 113 modulates the plurality of code symbols 310 based on a preset modulation scheme to generate a plurality of modulation symbols 320.

A scheme of mapping a plurality of code symbols on a plurality of modulation symbols in FIG. 3 is different from a scheme of sequentially mapping bits included in code symbols on modulation symbols in FIG. 2.

A mapping scheme proposed in an embodiment of the present disclosure makes the number of complex modulation symbols generated from a plurality of code symbols to be reduced or minimized, and the number of simple modulation symbols generated from one code symbol to be maximized. So, a problem due to a mapping scheme in FIG. 2 may be solved.

For example, in FIG. 3, 24 bits included in a bit group 315 including bits included in three code symbols 311, 312, and 313 are mapped on four code symbols 321, 322, 323, and 324, and the number of complex modulation symbols is 1. That is, a modulation symbol 321 is a complex modulation symbol.

Specially, the modulation symbol 321 is a complex modulation symbol which is generated from the three code symbols 311, 312, and 313, and the complex modulation symbol 321 is generated from two bits among bits included in each of the three code symbols 311, 312, and 313.

Meanwhile, each of modulation symbols 322, 323, and 324 is a simple modulation symbol which is generated from one code symbol. That is, the modulation symbol 322 is a simple modulation symbol which is generated from six bits among eight bits included in the code symbol 311, the modulation symbol 323 is a simple modulation symbol which is generated from six bits among eight bits included in the code symbol 312, and the modulation symbol 324 is a simple modulation symbol which is generated from six bits among eight bits included in the code symbol 313.

But, if a modulation symbol which is generated based on a scheme described as FIG. 3 is transmitted to a signal transmitting apparatus, the signal receiving apparatus needs to know which modulation symbol is a complex modulation symbol. This may be solved by assuming that a modulation symbol of which an order or location is predetermined between the signal transmitting apparatus and the signal receiving apparatus is a complex modulation symbol. If the order or location of the complex modulation symbol is not predetermined between the signal transmitting apparatus and the signal receiving apparatus, the signal transmitting apparatus needs to transmit information on the complex modulation symbol to the signal receiving apparatus.

A modulation symbol which is generated based on a modulation scheme proposed in an embodiment of the present disclosure enables a signal receiving apparatus to receive symbols and calculate a probability value for each of the received symbols. That is, if a signal transmitting apparatus generates a modulation symbol as described above, the signal receiving apparatus may calculate a probability on a symbol basis. So, complexity in demodulation is similar to complexity in a case that a binary channel code is used; however, it is possible to acquire a channel capacity gain of a non-binary channel code.

Meanwhile, in an embodiment of the present disclosure, a signal receiving apparatus calculates an LDR vector for a code symbol based on a probability value which is calculated from a received symbol according to a given q and M in order to maintain a channel capacity gain of a non-binary channel code. A scheme of calculating a probability value on demodulation in a signal receiving apparatus will be described below, and a detailed description will be omitted herein.

A modulation scheme as described in FIG. 3 will be generalized below.

If q and M are given, a size of a bit group required for generating a modulation symbol, i.e., the number of bits included in the bit group 1 is determined. The size of the bit group is determined as the least common multiple of log 2M and log 2q. In FIG. 3, the size of the bit group is the least common multiple of log 264=6 and log 2256=8, i.e., 24.

If the size of the bit group is determined, the number of code symbols a and the number of modulation symbols b may be determined. Here, the number of the code symbols a is determined as 1/log 2q (a=1/log 2q), and the number of the modulation symbols b is determined as 1/log 2M (b=1/log 2M). In FIG. 3, the number of the code symbols a is 3 (a=24/8=3), and the number of the modulation symbols b is 4 (b=24/6=4). That is, a size of a bit group which is required for mapping a code symbol on a modulation symbol (or the number of bits included in the bit group 1) is determined, and the number of code symbols a and the number of modulation symbols b are determined.

Upon generating b modulation symbols from a code symbols, the modulator 113 maps bits included in code symbols on modulation symbols in order that the number of complex modulation symbols generated from a plurality of code symbols becomes reduced or minimized.

In FIG. 3, the modulator 113 groups log 2M bits, i.e., six bits from each of the three code symbols 311, 312, and 313 to generate a modulation symbols, i.e., the three modulation symbols 322, 323, and 324, and groups (log 2q−log 2M=8−6=2) bits from each of the three code symbols 311, 312, and 313 to additionally generate (b−a=4−3=1) modulation symbol, i.e., the modulation symbol 321. The modulation symbol 321 is a complex modulation symbol which is generated from a plurality of code symbols.

In FIG. 3, upon generating the complex modulation symbol 321, the modulator 113 maps the first two bits from each of the three code symbols 311, 312, and 313 on one modulation symbol, however, it will be understood by those of ordinary skill in the art that location of bits which are included in the modulation symbol is not limited. That is, in FIG. 3, the modulator 113 needs to map the two bits among the bits included in each of the code symbols 311, 312, and 313 on the complex modulation symbol 321, and location of the two bits is not limited.

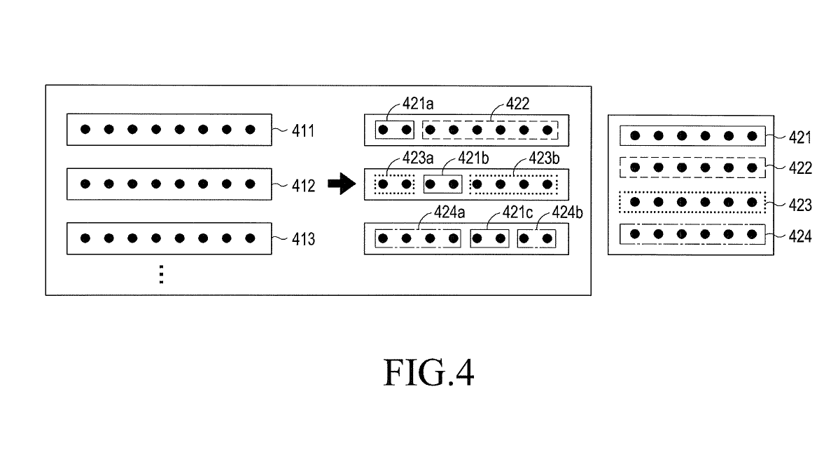

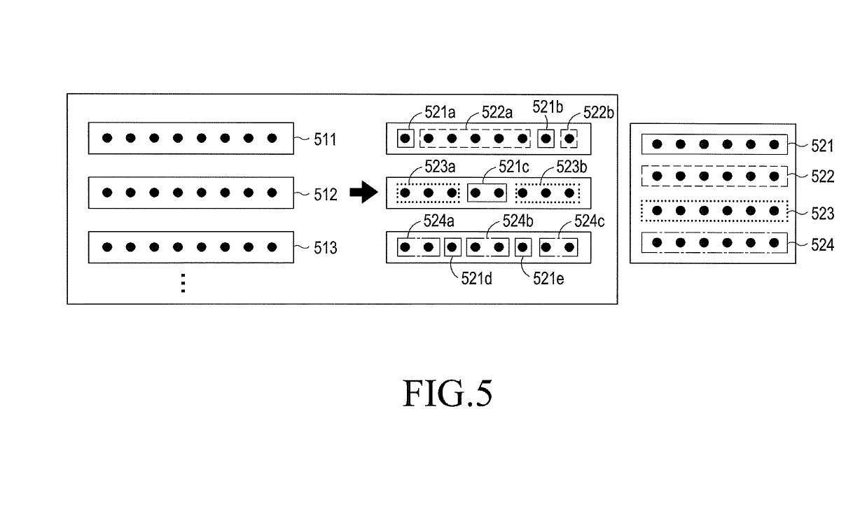

FIG. 4 illustrates another example of a scheme of mapping a code symbol on a modulation symbol in a wireless communication system supporting a non-binary channel code according to an embodiment of the present disclosure, and FIG. 5 illustrates still another example of a scheme of mapping a code symbol on a modulation symbol in a wireless communication system supporting a non-binary channel code according to an embodiment of the present disclosure.

Referring to FIG. 4, four modulation symbols 421, 422, 423, and 424 on GF(256) are generated from three code symbols 411, 412, and 413 based on a 64-QAM modulation scheme like FIG. 3.

However, in FIG. 4, one complex modulation symbol 421 is generated from the first and second bits 421a of the first code symbol 411, the third and fourth bits 421b of the second code symbol 412, and the fifth and sixth bits 421c of the third code symbol 413. The complex modulation symbol 421 is a modulation symbol which is generated from three code symbols 411, 412, and 413. In FIG. 4, it will be understood that each of remaining three modulation symbols 422, 423, and 424 except for the complex modulation symbol 421 is a simple modulation symbol which is generated from one code symbol. However, location of bits within a code symbol which are mapped on the three modulation symbols 422, 423, and 424 may be different from location as described in FIG. 3.

For another example, referring to FIG. 5, one complex modulation symbol 521 is generated from the first bit 521a and the seventh bit 521b of the first code symbol 511, the fourth and fifth bits 521c of the second code symbol 512, and the third bit 521d and the fifth bit 521e of the third code symbol 513. The modulation symbol 521 is a complex modulation symbol which is generated from three code symbols 511, 512, and 513. In FIG. 5, it will be understood that each of remaining three modulation symbols 522, 523, and 524 except for the complex modulation symbol 521 is a simple modulation symbol which is generated from one code symbol. However, location of bits within a code symbol which are mapped on the three modulation symbols 522, 523, and 524 may be different from location as described in FIG. 3 or FIG. 4.

As described above, location of bits within a code symbol in a mapping scheme in FIG. 4 or FIG. 5 is different from location as described in FIG. 3. However, in mapping schemes in FIGS. 3 to 5, the number of complex modulation schemes which are generated from a plurality of code symbols is 1, that is, the number of the complex modulation schemes which are generated from the plurality of code symbols becomes reduced or minimized.

Finally, in an embodiment of the present disclosure, if the number of complex modulation symbols which are generated from a plurality of code symbols becomes reduced or minimized, bits included in a modulation symbol may be located anywhere within a code symbol.

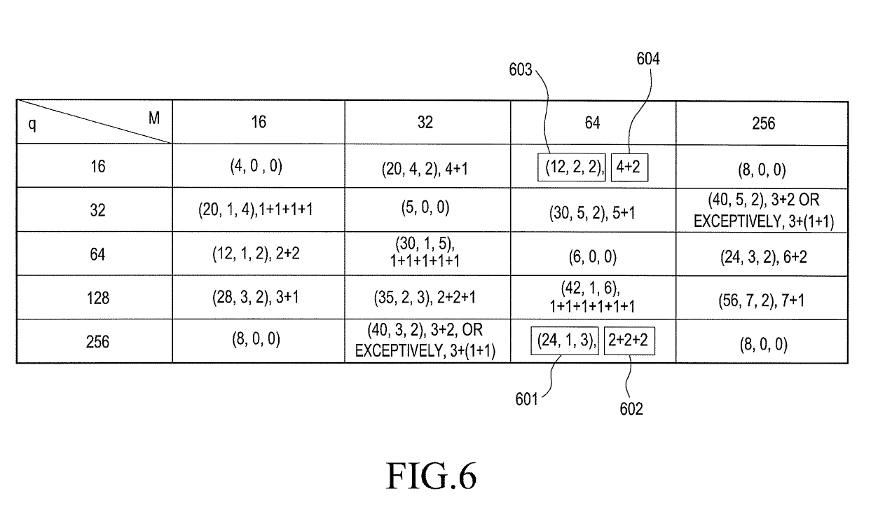

FIG. 6 illustrates a mapping relation between a code symbol and a modulation symbol which is based on an element value of a Galois field and a modulation order in a wireless communication system supporting a non-binary channel code according to an embodiment of the present disclosure.

A mapping relation between a code symbol and a modulation symbol in a case that q=256 and M=64 has been described with reference to FIGS. 3 to 5. At this time, a size of a bit group 1 is 24, and the number of modulation symbols which are generated from a plurality of code symbols m is 1. The number of code symbols in which bits included in a complex modulation symbol are included n is 3. That is, if q=256 and M=64, in order for a modulator to map a code symbol on a modulation symbol thereby reducing or minimizing the number of complex modulation symbols, the size of the bit group needs to be 24, the number of complex modulation symbols needs to be 1, and bits included in one complex modulation symbol need to be generated from three code symbols. This is illustrated like a reference sign 601 in FIG. 6.

Meanwhile, “2+2+2” 602 indicates a form of bits included in a complex modulation symbol. That is, “2+2+2” 602 means that six bits included in a complex modulation symbol are generated from two bits of each of three code symbols.

For another example, a mapping relation between a code symbol and a modulation symbol in a case that q=16 and M=64 will be described below.

Referring to reference signs 603 and 604, (l, m, n)=(12, 2, 2), and a form with which a modulation symbol is generated from a plurality of code symbols is “4+2”. This means that the number of bits within a bit group required for modulation symbol mapping is 12, the number of complex modulation symbols is 2, four bits among six bits included in each complex modulation symbol are generated from one code symbol, and remaining two bits are generated from other code symbol, in a case that q=16 and M=64.

An embodiment of the present disclosure may support various GF(q) and modulation schemes according to q and M using a mapping relation between a code symbol and a modulation symbol in FIG. 6. So, if a non-binary channel code is used, it is possible to maintain complexity similar to a binary channel code and perform an AMC scheme thereby a channel gain according to a non-binary channel code may be acquired.

Meanwhile, parameters 1, m, and n which are determined in a mapping scheme between a code symbol and a modulation symbol according to an embodiment of the present disclosure will be determined below.

(1) The number of bits included in a bit group 1: the least common multiple of log 2M and log 2q. That is, 1=a×log 2M=b×log 2q. Here, a denotes the number of required code symbols, and b denotes the number of generated modulation symbols.

(2) The number of complex modulation symbols which are generated from a plurality of code symbols m:

if M<q, m=(a−b), and

if M>q, m=a.

However, if a=1 or b=1, l=0, that is, if a=1 or b=1, a complex modulation symbol is not generated.

(3) The number of code symbols which are used for generating a complex modulation symbol n:

if M<q, n=ceiling{M/(q−M)}, that is, n is a minimum natural number which is greater than or equal to M/(q−M), and

if M>q, n=ceiling{M/q}, that is, n is a minimum natural number which is greater than or equal to M/q

However, the definition of the parameters is for an aspect of a signal transmitting apparatus. So, the parameters may be defined again for an aspect of a signal receiving apparatus, and this will be described below.

The parameter l may be defined as the number of bits included in a bit group like the signal transmitting apparatus.

The parameter m may be defined as the number of complex received symbols which are divided among received symbols. Here, the division means that bits included in a complex received symbol need to be divided based on the numbers of bits included in a code symbol per code symbol when the signal receiving apparatus calculates a probability value of the complex received symbol since the complex received symbol is generated based on a plurality of code symbols.

The parameter n may be defined as the number of bit groups which are generated by dividing bits when the signal receiving apparatus calculates a probability of a complex received symbol.

An example of calculating a probability value for a complex received symbol in the signal receiving apparatus will be described with reference to FIG. 8, and a detailed description will be omitted herein.

However, in the above description, parameters l, m, and n which are defined in an aspect of a signal transmitting apparatus have been used. So, it will be noted that the parameters l, m, and n which are defined in the aspect of the signal transmitting apparatus may be still used even though an operation of a signal receiving apparatus is described for unifying the terminologies.

A scheme of mapping a code symbol on a modulation symbol thereby reducing or minimizing the number of complex modulation symbols in a wireless communication system using a non-binary channel code according to an embodiment of the present disclosure has been described above.

In an embodiment of the present disclosure, bits included in a complex modulation symbol will be described with a signal constellation which is based on a Grey rule in FIG. 7.

A signal constellation of bits included in a modulation symbol generated from a plurality of code symbols in a wireless communication system supporting a non-binary channel code according to an embodiment of the present disclosure will be described below.

FIG. 7 illustrates a signal constellation of bits included in a modulation symbol generated from a plurality of code symbols in a wireless communication system supporting a non-binary channel code according to an embodiment of the present disclosure.

Referring to FIG. 7, an example that four modulation symbols are generated from three code symbols as described in FIG. 3 if q=8 and M=6 is shown in a left side. If a signal transmitting apparatus generates a complex modulation symbol 701 using six bits 703 included in three code symbols, a signal constellation to which a Grey rule is applied on a 2-bit basis is used as shown in a right side.

The Grey rule is a rule in which an average error probability of a symbol is decreased by allocating a Grey code thereby only one bit is different between adjacent symbols. That is, in the signal constellation as shown in the right sided in FIG. 7, the Grey rule is applied on a 2-bit basis in order for the signal transmitting apparatus to generate a complex modulation symbol using respective two bits 703 which are generated from a plurality of code symbols.

That is, in the bits 703 included in the complex modulation symbol 701, if a value which respective two bits included in three code symbols may have is expressed as one of 0, 1, 2, and 3, the complex modulation symbol 701 may be generated according to the signal constellation. In a case that an error occurs in one received symbol, error propagation to a plurality of code symbols may be prevented if the signal constellation is used.

However, performance does not change even if any signal constellation is used for simple modulation symbols 701, 702, and 703. So, even though the signal constellation to which the Grey rule is applied is not used for the simple modulation symbols 701, 702, performance may be maintained.

A scheme of mapping a code symbol on a modulation symbol in order that the number of complex modulation symbols becomes reduced or minimized in a case that a plurality of modulation symbols are generated from a plurality of bit groups of code symbols in a wireless communication system supporting a non-binary channel code has been described above.

A scheme of demodulating a received symbol in a signal receiving apparatus corresponding to a modulation scheme according to an embodiment of the present disclosure will be described below.

A demodulation scheme of a signal receiving apparatus in a wireless communication system supporting a non-binary channel code according to an embodiment of the present disclosure will be described with reference to FIG. 8.

FIG. 8 illustrates a demodulation scheme of a signal receiving apparatus in a wireless communication system supporting a non-binary channel code according to an embodiment of the present disclosure.

Referring to FIG. 8, it will be assumed that a signal receiving apparatus receives a symbol after a modulation symbol is generated according to a scheme in FIG. 3 and transmitted. As described in FIG. 3, a received symbol 1 821 is a complex received symbol which corresponds to a complex modulation symbol which is generated from three code symbols in a signal transmitting apparatus, and remaining three received symbols, i.e., a received symbol 2 822, a received symbol 3 823, and a received symbol 4 824 are simple received symbols which correspond to simple modulation symbols which are generated from one code symbol.

For each of the simple received symbol 2 822, the simple received symbol 3 823, and the simple received symbol 4 824, the signal receiving apparatus generates a probability vector of a length 64 by calculating a probability for 64 (26=64) bit values which may be generated in six bits included in a related simple received symbol. In FIG. 8, a probability vector of a length 64 is generated for the simple received symbol 4 824.

Meanwhile, six bits included in the complex received symbol 821 are generated from three code symbols 311, 312, and 313. So, in an embodiment of the present disclosure, the signal receiving apparatus does not generate a probability vector of a length 64 for the complex received symbol 821, and generates three probability vectors of a length 4 for six bits which are generated from different code symbols. That is, each of the three probability vectors of the length 4 corresponds to two bits included in each of the different code symbols. In an embodiment of the present disclosure, this probability vector will be defined as a reduced probability vector, and the reduced probability vector is a probability vector which is reduced per code symbol bit for a complex received symbol.

In FIG. 8, a reduced probability vector 811 of a length 4 is generated for the last two bits 801.

A scheme of generating the reduced probability vector of the length 4 for the last two bits 801 among six bits included in the complex received symbol 801 will be described below.

Similar to a scheme of calculating a probability vector for a simple received symbol, the signal receiving apparatus calculates a non-reduced probability vector of a length 64 for the six bits included in the complex received symbol 821. Values which the last two bits 801 may have are 00, 01, 10, and 11. A reduced probability vector of a length 4 may be generated by summing all probability values with four values among 64 probability values. That is, the number of probability values that a value of the last two bits 801 is 00 among the 64 probability values is 16, so a probability that the value of the last two bits 801 is 00 is calculated by summing the 16 probability values. Probabilities that values of the last two bits 801 are 01, 10, and 11 are calculated with the same scheme. So, a reduces probability vector of a length 4 is generated.

In a case that it will be assumed that the last two bits 801 included in the complex received symbol 1 821 and the six bits included in the simple received symbol 4 824 are generated from a code symbol 3 313 in FIG. 3, for example, a probability vector 813 for the code symbol 3 313 of a length 256 is generated by multiplying the reduced probability vector 811 of the length 4 and a probability vector 812 of a length 64 based on a Kronecker product. The probability vector 813 is input to a decoder 133 as a probability vector of a length 256 for the code symbol 3 313.

Like this, the signal receiving apparatus detects a probability vector of a length 4 for the first two bits among bits included in the complex received symbol 1 821, generates a probability vector of a length 256 for a code symbol 1 311 by multiplying the probability vector of the length 4 and a probability vector of length 64 which is detected for the simple received symbol 2 822, and outputs the probability vector of the length 256 for the code symbol 1 311 to the decoder 133. The signal receiving apparatus detects a probability vector of a length 4 for the second two bits among the bits included in the complex received symbol 1 821, generates a probability vector of a length 256 for a code symbol 2 312 by multiplying the probability vector of the length 4 and a probability vector of length 64 which is detected for the simple received symbol 3 823, and outputs the probability vector of the length 256 for the code symbol 2 312 to the decoder 133.

The demodulation process will be summarized below.

A signal receiving apparatus detects a probability vector V2 of a length 64 for M (in FIG. 8, M=6) bits for a simple received symbol. The signal receiving apparatus detects a reduced probability vector V1 which corresponds to a length (in FIG. 8, a length is 4) for each of bits included in the same code symbol as a code symbol which is used for generating a simple received symbol for a complex received symbol. The signal receiving apparatus may detect a total probability vector V3 for a related code symbol by multiplying the reduced probability vector V1 for the complex received symbol and the probability vector V2 for the simple received symbol, and output the total probability vector V3 to a decoder 133.

Using this decoding scheme, the signal receiving apparatus may transfer probability information calculated from a received symbol to a decoder, and maintain a channel capacity gain which a non-binary channel code has.

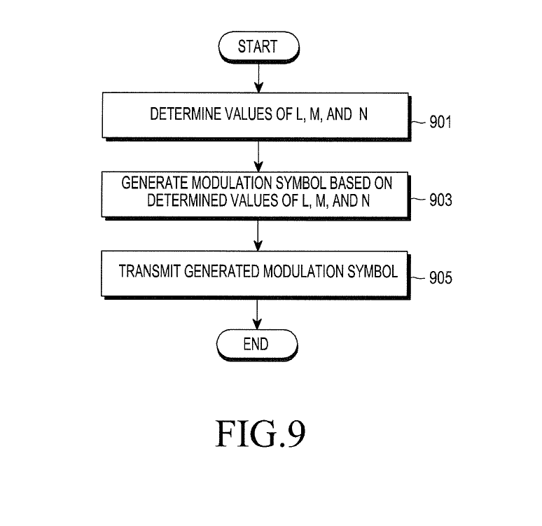

A demodulation scheme of a signal receiving apparatus in a wireless communication system supporting a non-binary channel code according to an embodiment of the present disclosure has been described with reference to FIG. 8, and an operating process of a signal transmitting apparatus in a wireless communication system supporting a non-binary channel code according to an embodiment of the present disclosure will be described with reference to FIG. 9.

FIG. 9 illustrates an operating process of a signal transmitting apparatus in a wireless communication system supporting a non-binary channel code according to an embodiment of the present disclosure.

Referring to FIG. 9, a modulator 113 in a signal transmitting apparatus 110 determines values of parameters l, m, and n that result in the number of complex modulation symbols which are generated from a plurality of code symbols based on q and M to be reduced or minimized at operation 901. As described in FIG. 6, the values of the parameters l, m, and n may be predetermined and stored in a storage unit (not shown in FIG. 1) in the signal transmitting apparatus 110 with a table form.

The modulator 113 generates a modulation symbol based on the determined values of the parameters l, m, and n in order that the number of complex modulation symbols is reduced or minimized at operation 903. Here, which modulation symbol is generated as a complex modulation symbol may be predetermined between the signal transmitting apparatus 110 and a signal receiving apparatus 130 or may be determined based on a default value. Alternatively, the signal transmitting apparatus 110 may generate a complex modulation symbol from a modulation symbol, and transmit information indicating that the complex modulation symbol is generated from the modulation symbol to the signal receiving apparatus 130. The modulator 113 may use a constellation to which a Grey rule is applied upon generating a complex modulation symbol. Further, the modulator 113 may use the constellation to which the Grey rule is applied upon generating a simple modulation symbol. For bits per code symbol which is used for generating a complex modulation symbol, the modulator 113 uses a constellation to which the Grey rule is applied by a size which corresponds to the number of the bits per code symbol.

A transmitter (not shown in FIG. 1) in the signal transmitting apparatus 110 transmits the generated modulation symbol to the signal receiving apparatus 130 through a channel 120 at operation 905.

Although FIG. 9 illustrates an operating process of a signal transmitting apparatus in a wireless communication system supporting a non-binary channel code according to an embodiment of the present disclosure, various changes could be made to FIG. 9. For example, although shown as a series of operations, various operations in FIG. 9 could overlap, occur in parallel, occur in a different order, or occur multiple times.

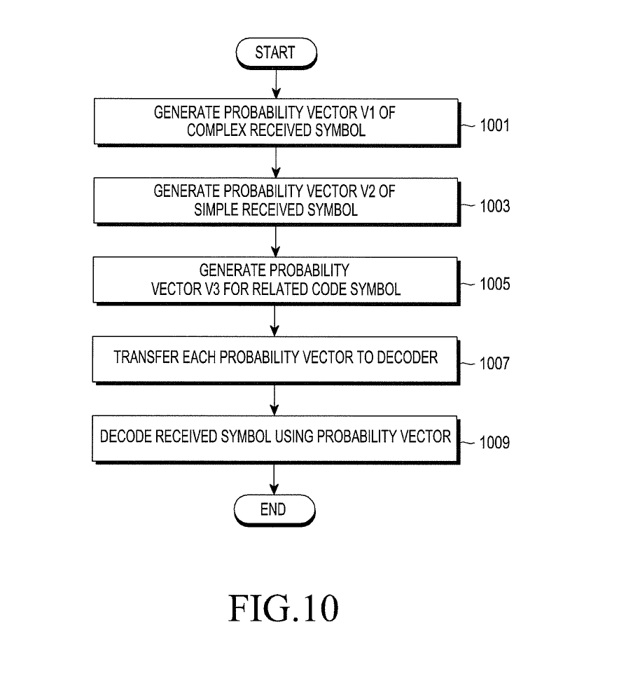

An operating process of a signal transmitting apparatus in a wireless communication system supporting a non-binary channel code according to an embodiment of the present disclosure has been described with reference to FIG. 9, and an operating process of a signal receiving apparatus in a wireless communication system supporting a non-binary channel code according to an embodiment of the present disclosure will be described with reference to FIG. 10.

FIG. 10 illustrates an operating process of a signal receiving apparatus in a wireless communication system supporting a non-binary channel code according to an embodiment of the present disclosure.

Referring to FIG. 10, a signal receiving apparatus 130 generates a probability vector V1 of a complex received symbol as a received symbol which corresponds to a complex modulation symbol which are generated from a plurality of code symbols at operation 1001. For a complex modulation symbol, the signal receiving apparatus 130 generates a reduced probability vector per code symbol bit. In an example in FIG. 8, the signal receiving apparatus 130 generates a reduced probability vector of a length 4 for respective two bits in a received symbol 1 821. The signal receiving apparatus 130 may know whether a received symbol is a complex received symbol based on a rule between a signal transmitting apparatus 110 and the signal receiving apparatus 130 or information received from the signal transmitting apparatus 110.

A demodulator 131 in the signal receiving apparatus 130 generates a probability vector V2 of a simple received symbol which corresponds to a simple modulation symbol which is generated from one code symbol at operation 1003. In FIG. 8, a probability vector of a length 64 is generated per received symbol for each of received symbols 2, 3, and 4 822, 823, and 824.

The demodulator 131 generates a probability vector for a related code symbol by multiplying probability vectors which correspond to bits included in the same code symbol at operation 1005. In FIG. 8, a probability vector V3 813 for a related code symbol is generated by multiplying a probability vector V1 811 and a probability vector V2 812.

The demodulator 131 transfers each probability vector which is generated per code symbol to a decoder 133 at operation 1007. The decoder 133 decodes a received symbol using the probability vector per code symbol at operation 1009.

Although FIG. 10 illustrates an operating process of a signal receiving apparatus in a wireless communication system supporting a non-binary channel code according to an embodiment of the present disclosure, various changes could be made to FIG. 10. For example, although shown as a series of operations, various operations in FIG. 10 could overlap, occur in parallel, occur in a different order, or occur multiple times.

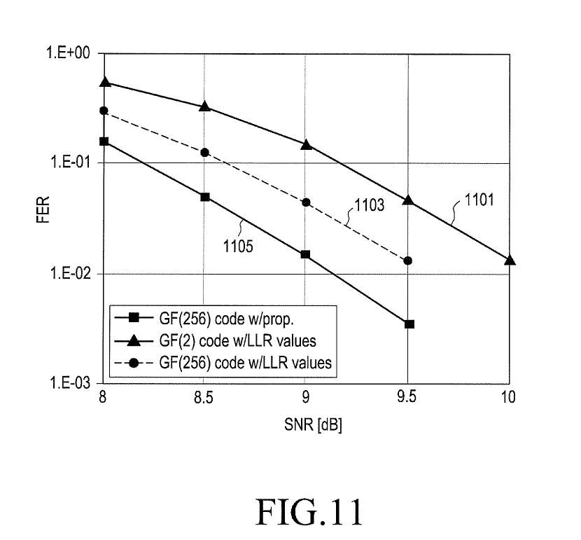

An operating process of a signal receiving apparatus in a wireless communication system supporting a non-binary channel code according to an embodiment of the present disclosure has been described with reference to FIG. 10, and performance of a data encoding/decoding scheme proposed in a wireless communication system supporting a non-binary channel code according to an embodiment of the present disclosure will be described with reference to FIG. 11.

FIG. 11 illustrates performance of a data encoding/decoding scheme proposed in a wireless communication system supporting a non-binary channel code according to an embodiment of the present disclosure.

Referring to FIG. 11, performance graph in FIG. 11 indicates performance in a case that a modulation symbol which is generated by modulating code symbols generated from a non-binary channel code which is defined on a GF(256) based on a 64-QAM modulation scheme is transmitted. The performance graph in FIG. 11 indicates performance in a case that the non-binary channel code is a non-binary low density parity check (LDPC) code.

In FIG. 11, it will be understood that performance 1105 of a GF(256) code in a case that a modulation scheme and a demodulation scheme according to an embodiment of the present disclosure are used is better than performance 1103 of a GF(256) code in a case that a binary channel code is used in a general IEEE 802.16e communication system by 1.0 dB, and better than performance 1101 of a GF(256) code in a case that a modulation scheme and a demodulation scheme in FIG. 2 are used by 0.5 dB. Here, the performance graph in FIG. 11 indicates performance in a case that the binary channel code is a binary LDPC code.

As is apparent from the foregoing description, an embodiment of the present disclosure enables to encode/decode data in a wireless communication system supporting a non-binary channel code.

An embodiment of the present disclosure enables to encode/decode data thereby supporting various modulation schemes in a wireless communication system supporting a non-binary channel code.

An embodiment of the present disclosure enables to encode/decode data thereby generating a modulation symbol based on a Galois field element value of a non-binary channel code and a modulation order in a wireless communication system supporting a non-binary channel code.

An embodiment of the present disclosure enables to encode/decode data thereby supporting adaptive modulation and encoding using one non-binary channel code in a wireless communication system supporting a non-binary channel code.

An embodiment of the present disclosure enables to map a code symbol on a modulation symbol thereby reducing or minimizing the number of modulation symbols generated from a plurality of code symbols in a wireless communication system supporting a non-binary channel code.

An embodiment of the present disclosure enables to encode/decode data thereby providing a signal constellation for bits included in a modulation symbol generated from a plurality of code symbols in a wireless communication system supporting a non-binary channel code.

An embodiment of the present disclosure enables to encode/decode data thereby demodulating a received symbol with a low complexity in a signal receiving apparatus in a wireless communication system supporting a non-binary channel code.

An embodiment of the present disclosure enables to determine a probability value for a received symbol which corresponds to a modulation symbol generated from a plurality of code symbols in a wireless communication system supporting a non-binary channel code.

Certain aspects of the present disclosure may also be embodied as computer readable code on a non-transitory computer readable recording medium. A non-transitory computer readable recording medium is any data storage device that can store data, which can be thereafter read by a computer system. Examples of the non-transitory computer readable recording medium include read only memory (ROM), random access memory (RAM), CD-ROMs, magnetic tapes, floppy disks, optical data storage devices, and carrier waves (such as data transmission through the Internet). The non-transitory computer readable recording medium can also be distributed over network coupled computer systems so that the computer readable code is stored and executed in a distributed fashion. In addition, functional programs, code, and code segments for accomplishing the present disclosure can be easily construed by programmers skilled in the art to which the present disclosure pertains.

It can be appreciated that a method and apparatus according to an embodiment of the present disclosure may be implemented by hardware, software and/or a combination thereof. The software may be stored in a non-volatile storage, for example, an erasable or re-writable ROM, a memory, for example, a RAM, a memory chip, a memory device, or a memory integrated circuit (IC), or an optically or magnetically recordable non-transitory machine-readable (e.g., computer-readable), storage medium (e.g., a compact disk (CD), a digital versatile disk (DVD), a magnetic disk, a magnetic tape, and/or the like). A method and apparatus according to an embodiment of the present disclosure may be implemented by a computer or a mobile terminal that includes a controller and a memory, and the memory may be an example of a non-transitory machine-readable (e.g., computer-readable), storage medium suitable to store a program or programs including instructions for implementing various embodiments of the present disclosure.

The present disclosure may include a program including code for implementing the apparatus and method as defined by the appended claims, and a non-transitory machine-readable (e.g., computer-readable), storage medium storing the program. The program may be electronically transferred via any media, such as communication signals, which are transmitted through wired and/or wireless connections, and the present disclosure may include their equivalents.

An apparatus according to an embodiment of the present disclosure may receive the program from a program providing device which is connected to the apparatus via a wire or a wireless and store the program. The program providing device may include a memory for storing instructions which instruct to perform a content protect method which has been already installed, information necessary for the content protect method, and the like, a communication unit for performing a wired or a wireless communication with a graphic processing device, and a controller for transmitting a related program to a transmitting/receiving device based on a request of the graphic processing device or automatically transmitting the related program to the transmitting/receiving device.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method for transmitting data in a transmitting apparatus in a wireless communication system, the method comprising:
generating at least one modulation symbol by modulating at least one code symbol based on a predetermined modulation scheme; and
transmitting the at least one modulation symbol to a receiving apparatus, wherein the generating of the at least one modulation symbol comprises generating the at least one modulation symbol from the at least one code symbol thereby minimizing a number of complex modulation symbols generated from a plurality of code symbols.

2. The method of claim 1, wherein generating the at least one modulation symbol further comprises generating the least one modulation symbol from the at least one code symbol based on an element value q of a Galois field of a non-binary channel code and a modulation order M of the modulation scheme.

3. The method of claim 2, wherein generating the at least one modulation symbol further comprises:
determining a number of bits l required for modulation symbol generation based on the element value q of the Galois field of the non-binary channel code and the modulation order M of the modulation scheme;
determining a number of required code symbols a and a number of generated modulation symbols b based on the number of bits l required for the modulation symbol generation;
determining a value m that results in the number of the complex modulation symbols to be reduced if the b modulation symbols are generated based on the a code symbols; and
mapping the l bits on the b modulation symbols based on the value m that results in the number of the complex modulation symbols to be reduced.

4. The method of claim 3, wherein the number of bits l is a least common multiple of log₂ M and log₂ q,
wherein m=(a−b) if M<q, and m=a if M>q,
wherein l=0 if a=1 or b=1,
wherein the m modulation symbols are generated from n code symbols, and
wherein n=ceiling{M/(q−M)} if M<q, and n=ceiling{M/q} if M>q.

5. The method of claim 1, wherein generating the at least one modulation symbol further comprises generating the at least one modulation symbol from the at least one code symbol based on a mapping relation between the at least one code symbol and the at least one modulation symbol which is determined based on an element value q of a Galois field of a non-binary channel code and a modulation order M of the modulation scheme.

6. A method for receiving data in a receiving apparatus in a wireless communication system, the method comprising:
receiving at least one modulation symbol from a transmitting apparatus,
wherein the at least one modulation symbol is generated by modulating at least one code symbol based on a predetermined modulation scheme, and
wherein the at least one modulation symbol is generated from the at least one code symbol to thereby reduce a number of complex modulation symbols that are generated from a plurality of code symbols.

7. The method of claim 6, wherein the at least one modulation symbol is generated from the at least one code symbol based on an element value q of a Galois field of a non-binary channel code and a modulation order M of the modulation scheme.

8. The method of claim 7, wherein the at least one modulation symbol is generated by mapping l bits on b modulation symbols based on a value m that results in the number of the complex modulation symbols to be reduced, l denotes a number of bits required for modulation symbol generation, and b denotes a number of generated modulation symbols, and
wherein the number of bits l is determined based on q and M, and b is determined based on l, and a number of required code symbols a is determined based on l.

9. The method of claim 8, wherein the number of bits l is a least common multiple of log₂ M and log₂ q,
wherein, if M<q, m=(a−b), if M>q, m=a, if a=1 or b=1, l=0,
wherein the m modulation symbols are generated from n code symbols, and
wherein, if M<q, n=ceiling{M/(q−M)}, and if M>q, n=ceiling{M/q}.

10. The method of claim 6, wherein the at least one modulation symbol is generated from the at least one code symbol based on a mapping relation between the at least one code symbol and the at least one modulation symbol which is determined based on an element value q of a Galois field of the non-binary channel code and a modulation order M of the modulation scheme.

11. A transmitting apparatus in a wireless communication system, the transmitting apparatus comprising:
a modulator configured to generate at least one modulation symbol by modulating at least one code symbol based on a predetermined modulation scheme; and
a transmitter configured to transmit the at least one modulation symbol to a receiving apparatus, wherein the modulator generates the at least one modulation symbol from the at least one code symbol thereby minimizing a number of complex modulation symbols generated from a plurality of code symbols.

12. The transmitting apparatus of claim 11, wherein the modulator is configured to generate the least one modulation symbol from the at least one code symbol based on an element value q of a Galois field of a non-binary channel code and a modulation order M of the modulation scheme.

13. The transmitting apparatus of claim 12, wherein the modulator is configured to:
determine a number of bits l required for modulation symbol generation based on the element value q of the Galois field of the non-binary channel code and the modulation order M of the modulation scheme,
determine a number of required code symbols a and a number of generated modulation symbols b based on the number of bits l required for the modulation symbol generation,
determine a value m that results in the number of the complex modulation symbols to be reduced when the b modulation symbols are generated based on the a required code symbols, and
map the l bits on the b modulation symbols based on the value m that results in the number of the complex modulation symbols to be reduced.

14. The transmitting apparatus of claim 13, wherein the number of bits l is a least common multiple of log₂ M and log₂ q,
wherein m=(a−b) if M<q, and m=a if M>q,
wherein l=0 if a=1 or b=1,
wherein the m modulation symbols are generated from n code symbols, and
wherein n=ceiling{M/(q−M)} if M<q, and n=ceiling{M/q} if M>q.

15. The transmitting apparatus of claim 11, wherein the modulator is configured to generate the at least one modulation symbol from the at least one code symbol based on a mapping relation between the at least one code symbol and the at least one modulation symbol which is determined based on an element value q of a Galois field of a non-binary channel code and a modulation order M of the modulation scheme.

16. A receiving apparatus in a wireless communication system, the receiving apparatus comprising:
a receiver configured to receive at least one modulation symbol from a transmitting apparatus,
wherein the at least one modulation symbol is generated by modulating at least one code symbol based on a predetermined modulation scheme, and
wherein the at least one modulation symbol is generated from the at least one code symbol to thereby reduce a number of complex modulation symbols that are generated from a plurality of code symbols.

17. The receiving apparatus of claim 16, wherein the at least one modulation symbol is generated from the at least one code symbol based on an element value q of a Galois field of a non-binary channel code and a modulation order M of the modulation scheme.

18. The receiving apparatus of claim 17, wherein the at least one modulation symbol is generated by mapping l bits on b modulation symbols based on a value m that results in the number of the complex modulation symbols to be reduced, l denotes a number of bits required for modulation symbol generation, and b denotes a number of generated modulation symbols, and
wherein the number of bits l is determined based on q and M, and b is determined based on l, and a number of required code symbols a is determined based on l.

19. The receiving apparatus of claim 18, wherein the number of bits l is a least common multiple of log₂ M and log₂ q,
wherein, if M<q, m=(a−b), when M>q, m=a, if a=1 or b=1, l=0,
wherein the m modulation symbols are generated from n code symbols, and
wherein, if M<q, n=ceiling{M/(q−M)}, and if M>q, n=ceiling{M/q}.

20. The receiving apparatus of claim 16, wherein the at least one modulation symbol is generated from the at least one code symbol based on a mapping relation between the at least one code symbol and the at least one modulation symbol which is determined based on an element value q of a Galois field of a non-binary channel code and a modulation order M of the modulation scheme.
